(19) United States
(12) Patent Application Publication
(10) Pub. No.: US 2005/0289536 A1
(43) Pub. Date: Dec. 29, 2005

(54) Automated deployment of an application

(75) Inventors: Ranjit Nayak, Austin, TX (US); Sridhar Sudarsan, Austin, TX (US); Vishwanath Venkataramappa, Austin, TX (US); Qinhua Wang, Pittsburg, PA (US); Leigh Allen Williamson, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Coporation, Armonk, NY (US)

(21) Appl. No.: 10/874,495

(22) Filed: Jun. 23, 2004

(51) Int. Cl. G06F 9/44

(52) U.S. Cl. 717/174

(57) ABSTRACT

Methods, systems, and media to automatically deploy an, e.g., a JS2EE file between environments are disclosed. Embodiments include hardware and/or software for selecting one or more applications in an original system for export. The applications along with their corresponding application data, configuration data, and descriptor files, are compressed into one or more archive files such as Enterprise Archives (EARs). Variable configuration data associated with the target environment is identified so the values of the variable configuration data can be adapted for the target environment. Then, the target environment is adapted for installation of the application and the application is installed in the target environment. Advantageously, this deployment of the application may reduce the chance of user error, require less J2EE knowledge and script maintenance, and complete faster than deployments effected manually.

### FIELD OF INVENTION

The present invention is in the field of software installation. More particularly, the present invention relates to methods and arrangements to deploy an application between environments such as development, testing, and production environments for Java 2 Platform, Enterprise Edition (J2EE) applications.

### BACKGROUND

The development and deployment of business application software is a complex project. Software developers not only have to design, develop, and test the software but also spend considerable effort in configuring various testing environments for installation and execution of the software. One application environment, Java 2 Platform, Enterprise Edition (J2EE), simplifies software development and reduces programmer training by including standardized, reusable modular components. The J2EE platform is a platform-independent, Java-centric environment from Sun MicroSystems for developing, building and deploying Web-based enterprise applications online. The J2EE platform consists of a set of services, APIs, and protocols that provide the functionality for developing multi-tiered, Web-based applications. For instance, at the client tier, the J2EE platform supports pure HTML, as well as Java applets or applications. The J2EE platform relies on Java™ Server Pages and servlet code to create HTML or other formatted data for the client. Enterprise JavaBeans (EJBs) provide a layer of logic for the platform. An EJB server provides functions such as threading, concurrency, security and memory management, all of which are typically transparent to the user. Java™ Database Connectivity (JDBC), which is the Java™ equivalent to Open Database Connectivity (ODBC), is the standard interface for Java™ databases. And, the Java™ servlet application program interface (API) provides a consistent interface for users without requiring a graphical user interface (GUI).

Although J2EE simplifies development of the software, users typically spend a great deal of time on deployment issues. Deployment of J2EE applications involves configuring the system environment and support resources of a target server, and installing the application into that system environment. The J2EE platform software applications often need to be moved between multiple environments to facilitate different stages of testing before the applications are ready for use via, e.g., an intranet or the Internet. In particular, software developers often move J2EE applications between various environments such as development, integration test, system test, load and stress test, and user acceptance test environments before deploying the applications into production environments.

Each deployment of the application typically involves configuration of the environment, which greatly slows down installation. More specifically, configuration of each system environment includes actions to link the software application to resources necessary for testing and execution. For example, an administrator may need to setup one or more EJB servers, databases, etc. Then, the administrator may configure links between parts of the application, and links with the servers, databases, libraries, applications, and/or other resources.

One problem is that customers manually configure environments and the application for installation. Manually configuring and deploying an assembled J2EE application is complicated, requiring a customer to have an extensive knowledge in the use of J2EE, especially for situations in which an application requires a server that is not an existing, default server. The exhaustive list of runtime settings, for instance, commonly includes choices such as whether to automatically load servlets or to pre-compile Java Server Page (JSP) files. These settings are comprehensive, detailed, and easy to blunder.

Another problem relates to the time to migrate between environments. The time to migrate between environments is so significant that project schedules are often delayed and customers tend to take short cuts in testing applications, risking even greater delays. For instance, a customer may deploy an application more than twenty times during a project. As a result, the customer frequently combines several test environments into one test environment to expedite completion of the project. The customer may combine, e.g., a build test environment and a pre-production test environment into a cursory, preliminary test, increasing the probability that a costly error will elude early detection.

Currently, customers and vendors try to reduce installation time by including data to describe environment configurations in archive files with the applications. In particular, customers or vendors compress application binaries, or files, with deployment descriptors into an Enterprise Archive (EAR) file and provide scripts via, e.g., Windows NT® or UNIX® scripted tools, to extract configuration data from the deployment descriptors to transfer the application to another environment. An EAR file contains an entire J2EE application including its components along with the deployment descriptors. Deployment descriptors may include, for instance, Extensible Markup Language (XML) files to provide meta information about the application and individual modules. Advantageously, XML files use common information formats so that data in a format described by the XML file can be interpreted by numerous platforms.

Typical modules within the EAR file include Enterprise JavaBeans (EJB), Web Archive (WAR) files, and Resource Adapter Archive (RAR) files. An EJB J2EE component that facilitates building of multi-tier client/server systems. The goal of EJB system is to allow developers to focus on the business architecture of a model, rather than the endless amounts of programming and coding needed to connect all the working parts. This task is left to EJB server vendors. Developers design or purchase EJB components and arrange them on a server.

A WAR file is a compressed file including servlets, JSPs and other resources to allow control of specific resources' behavior within an application server. The RAR file is a compressed file that includes connector code.

Unfortunately, the use of scripts to interpret data recovered via the deployment descriptors is very time-consuming at the front-end, requires extensive knowledge of the J2EE platform, and is high maintenance, often leading to errors. In addition, deployment of the application from one environment to the next is typically part of an administrator's responsibility and the administrator normally does not have the extensive knowledge of the J2EE platform necessary to create and maintain the script files.

Therefore, a need exists for methods and arrangements capable of automating deployment of an application between environments in a manner that is relatively simple in terms of, e.g., J2EE knowledge, and low maintenance with respect to script files, to reduce the delays and errors typically associated with deployment.

### SUMMARY OF THE INVENTION

The problems identified above are in large part addressed by methods and arrangements to deploy a software application between environments. One embodiment provides a method to deploy an application on a target environment. The method generally includes gathering static configuration data related to deployment of the application, the static configuration data describing a relationship between the application and another environment, wherein the relationship is applicable to deployment of the application onto the target environment and determining variable configuration data for the application based upon the target environment. The method may also include configuring the target environment for deployment of the application based upon the static configuration data and the variable configuration data and installing the application in the target environment.

Another embodiment provides an apparatus to deploy an application on a target environment. One apparatus includes a package module to gather static configuration data related to deployment of the application, the static configuration data describing a relationship between the application and another environment, wherein the relationship is applicable to deployment of the application onto the target environment and a policies module to determine variable configuration data for the application based upon the target environment. A further embodiment includes a configuration module to configure the target environment for deployment of the application based upon the static configuration data and the variable configuration data and an install module to install the application in the target environment.

One embodiment provides an application archive file for deploying an application on a target environment. One application archive file includes a package module to create an application archive file and package an application into the application archive file along with sufficient system configuration data to configure a system with which to run the application. A further embodiment includes an application selected for deployment on the target environment; and configuration data for adapting the target environment for deployment of the application comprising static configuration data related to deployment of an application, the static configuration data describing a relationship between the application and another environment, wherein the relationship is applicable to deployment of the application onto the target environment; and variable configuration data for the application based upon the target environment.

A further embodiment provides a machine-accessible medium containing instructions, which when executed by a machine, cause said machine to perform operations. The operations may include gathering static configuration data related to deployment of the application, the static configuration data describing a relationship between the application and another environment, wherein the relationship is applicable to deployment of the application onto the target environment and determining variable configuration data for the application based upon the target environment. The operations may also include configuring the target environment for deployment of the application based upon the static configuration data and the variable configuration data and installing the application in the target environment.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an embodiment of a system to deploy an application from an original environment to a target environment;

FIG. 2 depicts an example of a flowchart to illustrate the user interface of FIG. 1;

FIG. 3 depicts an embodiment of an extended EAR file such as the extended EAR file of FIG. 1;

FIG. 4 depicts an embodiment of an Application Deployment System to automatically configure an environment and install an application;

FIG. 5 depicts an embodiment of a simplified example of a computer system capable of deploying an application between environments such as the Application Deployment System of FIG. 4; and

FIG. 6 depicts an example of a flowchart to deploy an application between an original environment and a target environment.

### DETAILED DESCRIPTION OF EMBODIMENTS

### Introduction

The following is a detailed description of embodiments of the invention depicted in the accompanying drawings. The embodiments are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, methods and arrangements are contemplated to automate propagation of, e.g., a Java 2 Platform Enterprise Edition (J2EE) application between runtime systems for the convenience of a user such as an administrator. Advantageously, this propagation reduces the chance of user error, requires less J2EE knowledge and script maintenance, and completes faster than system configuration effected manually.

More specifically, the user may interact with an application deployment system to select one or more applications in an original system for export. The applications along with their corresponding application data, configuration data, and descriptor files, are compressed into one or more archive files such as Enterprise Archives (EARs). In some embodiments, the administrator then identifies static and variable configuration data based upon the target environment. For example, the static configuration data may include a node name, a cell name, and a host name; and the variable configuration data may include a log file name and a server name.

The system then compresses the variable configuration data with the EAR file(s) of the application(s) into an extended EAR and transmits the extended EAR to the target system for installation. In several embodiments, an application deployment system installs one or more of the application(s) stored in the extended EAR. In some embodiments, a user interacts with the application deployment system to select the application(s) to install. In further embodiments, the application deployment system may be internal to the target system and respond the receipt of the extended EAR by installing one or more of the applications.

Prior to installation, the application deployment system may create directories and databases, and install server instances and virtual hosts as necessary to provide resources to support the application(s). More specifically, if resources and/or structures described by the static or variable configuration data are not available in the target environment, the application deployment system will setup the resources and/or structures and, upon installation the application, link components of the application to the resources and/or structures as described in the deployment descriptor files. In one embodiment, the application deployment system may determine the variable configuration data, or a portion thereof, for the target environment configuration from default configuration data and/or from configuration data associated with the original environment.

### Detailed Description

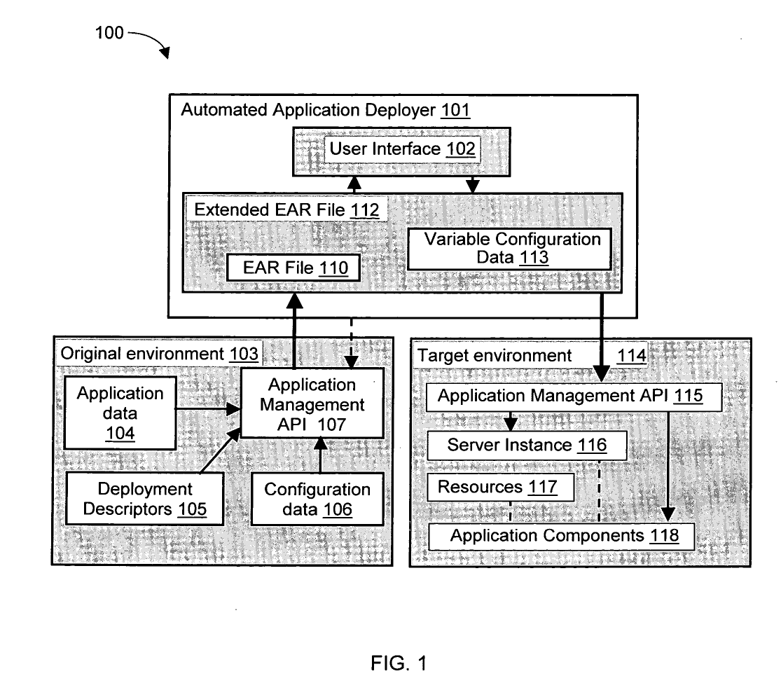

Turning now to the drawings, FIG. 1A depicts an embodiment of a system 100 to deploy an application from an original environment 103 to a target environment 114. More specifically, system 100 may configure target environment 114 and install the application automatically or based upon input from a user via user interface 102. For instance, system 100 may be part of a computer system of a software developer and may be designed to facilitate movement of applications from one testing environment, such as original environment 103, to another testing environment, such as target environment 114. System 100 allows a user such as a Java 2 Platform Enterprise Edition (J2EE) administrator, to move the application(s) between the environments in one operation. In some embodiments, system 100 may move the application from original environment 103 and deploy the application in target environment 114 as an automated response to, e.g., completion of testing for the application in original environment 103. In further embodiments, system 100 may interact with the user to adapt target environment 114 and the installation of the application for target environment 114.

Automated application deployer 101 may be software and/or hardware designed to interact with a user via user interface 102 to deploy the application. In many embodiments, automated application deployer 101 may be a software application installed on one or more computers such as servers. In further embodiments, automated application deployer 101 may be a software application installed on a partition of a logically partitioned system. For example, automated application deployer 101 may execute on a server of a clustered system to deploy J2EE applications between testing environments during the development of the J2EE applications.

Automated application deployer 101 includes user interface 102 and an extended EAR file 112. User interface 102 is optionally included to interact with a user to select an application to deploy in target environment 114. User interface 102 may also interact with the user to adapt configuration of target environment 114 and adapt installation of the application for target environment 1 14. Advantageously, user interface 102 provides the user with the ability to adapt target environment 114 and the installation of the application with little or no detailed knowledge of the J2EE platform. In particular, user interface 102 may provide the user with an opportunity to identify static and variable configuration data 113 for an application identified for deployment into target environment 114. Configuration data 106 may, e.g., describe access to directories and resources for the application. The static configuration data includes a portion of configuration data 106 that does not need to be adapted for target environment 114. Variable configuration data 113 is a configuration data that is adapted for target environment 114.

After identifying variable configuration data 113, the user may, e.g., describe access to directories and resources for the application in target environment 114. For example, after identifying the directory of a log file as variable configuration data 113, the user may select the new directory for the log file within target environment 114 via, e.g., a graphical user interface (GUI). Automated application deployer 101 then stores the new directory information in variable configuration data 113 of extended EAR file 112.

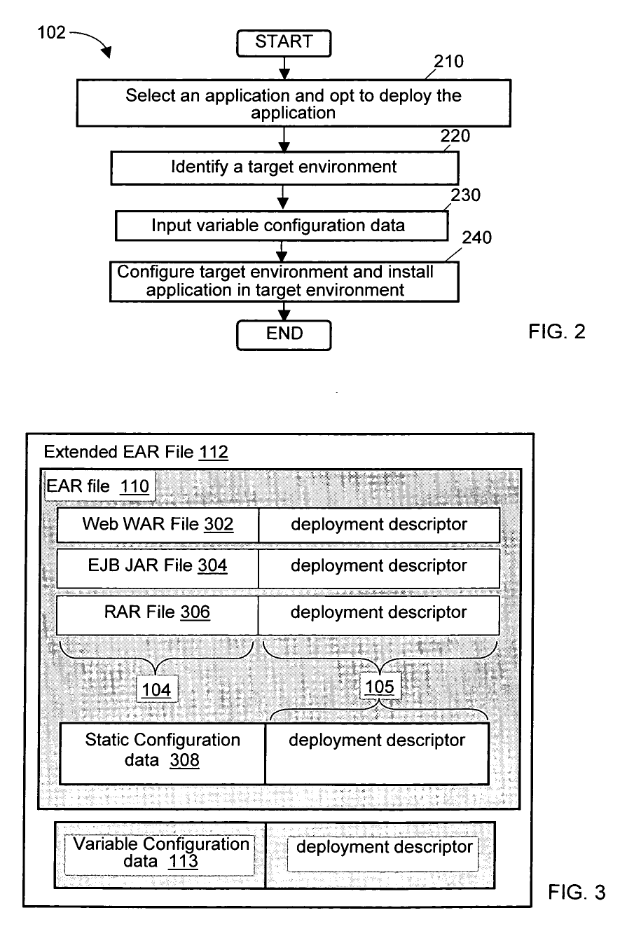

FIG. 2 depicts an example of a flowchart to illustrate the user interface 102 of FIG. 1. First, a user such as a J2EE administrator selects an application to deploy to target environment 114 (element 210). The user may select an application by, e.g., selecting an existing application in original environment 103, which may include selecting one or more directories for source objects. Subsequently, the user opts to deploy the application by choosing a menu option in development software, Deploy, or issuing a command at a prompt to deploy.

After selecting and opting to deploy the application (element 210), the user identifies a static environment, target environment 114, for deployment of the application (element 220). In one embodiment, the user may choose target environment 114 from a list of target environments offered by user interface 102 via a software development platform such as WebSphere®. In another embodiment, the user may choose target environment 114 by inserting the environment's identification in variable configuration data 113.

In response to selection of target environment 114, user interface 102 offers the user an opportunity to redefine some or all of configuration data 106 in variable configuration data 113. The portions of configuration data 106 that the user does not want to change may be identified as static configuration data. The user may then change the portion of configuration data 106 that varies between the original and target system, e.g., node name, cell name, host name, computer name, e.g. server name, data sources, scoping, tuning parameters, security, links between objects and processes, and the like, and store the modified configuration data in variable configuration data 113 (element 230). The user may also tune several parameters such as pool size, heap size, memory, connecting to databases, cache and the like, and store the modified configuration data in variable configuration data 113 (element 230). In some situations, the user may choose an option that allows variable configuration data 113 to be managed by a system management tool of the J2EE platform.

Once the user provides variable configuration data 113 (element 230), automated application deployer 101 transmits extended EAR file 112 to target environment 114 via application management API 115. Application management API 115 then adapts target environment 114 for the application based upon variable configuration data 113, static configuration data of configuration data 106, and deployment descriptors. After target environment 114 is set up, the application is installed and becomes available for the user to execute in target environment 114 (element 240). The flow chart may then repeat when the user wants to deploy the application into another environment. At this point, the environment in which the application is currently installed becomes the original environment 103 and the selected for deployment becomes the target environment 114. For example, the application may be transferred into another testing environment or to a production environment, depending upon the stage of development of the application and the project schedule.

Referring again to FIG. 1, extended EAR file 112 is an archive file such as a ZIP file compressed for transmission to target environment 114. Extended EAR file 112 includes an application adapted for installation in target environment 114. More specifically, extended EAR file 112 is a combination of an EAR file 110 and variable configuration data 113. EAR file 110 is a ZIP file of the application that includes application data 104, deployment descriptors 105, and configuration data 106. EAR file may be included in extended EAR file 112 as a ZIP file or decompressed and combined with variable configuration data 113.

In some embodiments, automated application deployer 101 creates EAR file 110 via application management application program interface (API) 107. In other embodiments, application management API 107 locates EAR file 110 in original environment 103 and transmits EAR file 110 to automated application deployer 101 for inclusion in extended EAR file 112. For example, automated application deployer 101 may receive an instruction from a user via user interface 102 to move an application from original environment 103 to target environment 114. In response, automated application deployer 101 may compress application data 104, deployment descriptors 105, and configuration data 106 into EAR file 110 and transmit EAR file 110 to automated application deployer 101 via application management API 107.

FIG. 3 depicts a more detailed view of extended EAR file 112. Extended EAR file 112 includes a J2EE application 302 bundled with its static configuration data 308 and variable configuration data 113. Extended EAR file 112 complies with the J2EE standard for an EAR file in its subpart EAR file 110. A J2EE application is a group of Web modules that collectively perform as a single entity. A Web Module is an entity consisting of one or more resources such as Hypertext Markup Language (HTML) files, Java class files, Java Server Page (JSP) files, XML files, etc.

Web modules are packaged in Web Archive (WAR) files 302. In some embodiments, the application management API 107 may also package Web source objects into a WAR file 302. A WAR file is a compressed file using a ZIP file format and compression scheme and contains a file called web.xml that allows a user to control the behavior of specific resources within the application computer. This includes creating object alias's, instructing the computer to load the object on computer startup, and other features. War files were created for Web-based objects, including JSPs, Hypertext Markup Language (HTML) pages, images, etc. HTML is a set of markup symbols or codes inserted in a file intended for display on a World Wide Web browser page. The markup tells the Web browser how to display a Web page's words and images for the user. At deployment time those objects are gathered up and bundled into the WAR file 302. Any Java objects such as model objects and EJBs are bundled up and put in the EAR along with WAR file 302.

Additionally, an EAR file 110 may include an EJB Java Archive (JAR) file 304 which is a file that contains class, image, and sound files for a Java applet gathered into a single file and compressed for faster downloading to a Web browser. In some embodiments, the EAR file 110 includes an EJB or other Java application program interfaces, to provide a user with platform independent component architecture definitions for multi-tier client/server systems. In other embodiments, extended EAR file 112 additionally includes a compressed file in (RAR) file 306. The RAR format is a J2EE standard for logic that connects application computers with legacy backend information systems.

An EAR file 110 is a JAR file encapsulating a J2EE application. In other words, EAR files contain WAR files 302, EJB JAR files 304, application resources, including deployment descriptors 105, formatted in XML for several of these archive files. EJB JAR file 304 may contain the class, image, and sound files for a Java web application (applet) gathered into a single file and compressed for faster downloading to a Web browser. Included in the EAR 110 and the WAR files 302 are the subdirectories that were created as the application was developed.

In addition, extended EAR file 112 includes information, such as static configuration data 308 and variable configuration data 113. In some embodiments, static configuration data 308 and variable configuration data 113 provide information to configure a server instance like server instance 116 in target environment 114 to run the application stored in EAR file 110. For instance, configuration data 106 and/or variable configuration data 113 may include, e.g. a server name, and, in further embodiments, may include resources 117. If server instance 116 and resources 117 already exist in target environment 114, automated application deployer 101 may link the application's components 118 upon installation to server instance 116 and resources 117. Otherwise, automated application deployer 101 may configure and install server instance 116 and resources 117 as necessary before linking them to the applications' components 118.

In several embodiments, original environment 103 and target environment 114 of system 100 may be any of several testing environments such as development, integrated testing, system test, load and stress test, and user acceptance test, or a production environment. Original environment 103 and/or target environment 114 may include one or computers and/or logical partitions of a logically partitioned computer that are communicative coupled for executing the application. For instance, there can be two installations of WebSphere® Application Server software on separate partitions of the same logically partitioned machine including original environment 103 and target environment 114. Further, automated application deployer 101 may be installed on one or both of the partitions, or in a third logical partition. WebSphere® is a set of Java-based tools from IBM® that allow customers to create and manage sophisticated business Web sites. The central WebSphere® tool is the WebSphere® Application Server (WAS), an application computer that a customer can use to connect Web site users with Java applications.

To further illustrate, automated application deployer 101 may be part of an enterprise application for a product manufacturing and distribution center. The distributor may record data related to parts, suppliers, customers, orders, etc, in spreadsheets. The vendor may use servlets to access, alter, and report data stored in the spreadsheets and update the servlets periodically to handle new types of parts and/or products to track. Automated application deployer 101 may interact with a manager for the product manufacturing and distribution center to deploy updated versions of the servlets. Advantageously, the later versions of the servlets can easily be installed by the manager in the various environments throughout the manufacturing and distribution center such as in parts servers, sales servers, marketing servers, testing servers, etc., even if the manager has little or no experience programming the servlets.

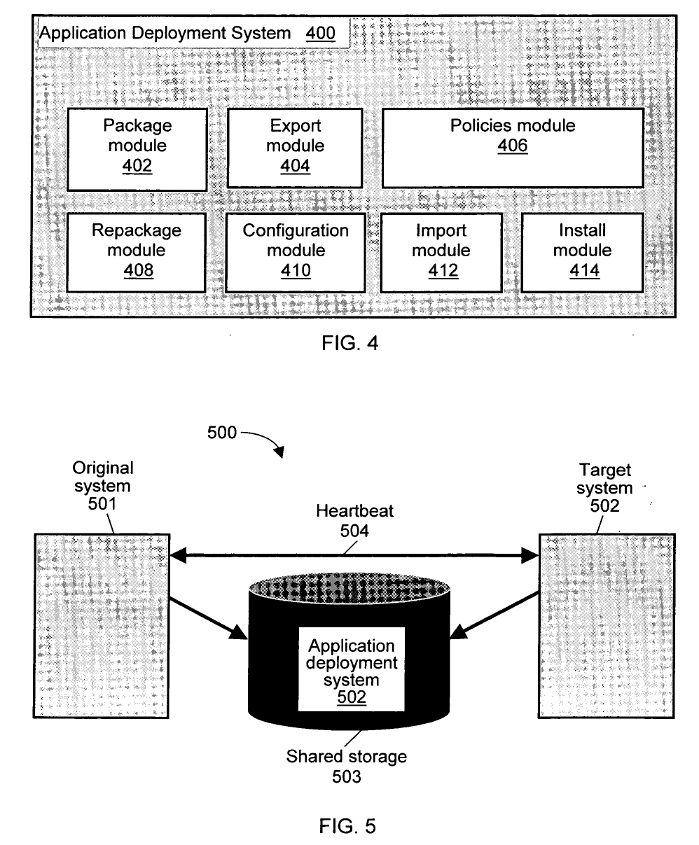

FIG. 4 depicts an embodiment of an Application Deployment System 400 adapted to automatically configure an environment and install an application. In order to automatically configure the environment and install the application, Application Deployment System 400 may include logic modules, such as logic modules 402-414. Logic modules 402-414 may be hardware or software modules and may aid the user by deploying an application bundle such as extended EAR 112 to a target environment 114 as illustrated in FIG. 1.

Logic modules 402-414 include a package module 402, an export module 404, a policies module 406, a repackage module 408, a configuration module 410, an import module 412, and an install module 414. Package module 402 compresses both application data and configuration data about the application into a J2EE standard EAR file. In many embodiments, package module 402 interfaces with an application management API in an original environment to generate the EAR file. In another embodiment, package module 402 may bundle the application without compression or into a compressed file that does not meet J2EE standards.

Export module 404 exports the EAR file to a directory of application deployment system 400 to adapt the EAR file for deployment to the target environment. For instance, application deployment system 400 may extend the EAR file by appending variable configuration data or modifies the configuration data included within the EAR file, to adapt the EAR file for deployment of the application into the target environment. In another embodiment, export module 404 exports the compressed information to other storage, such as portable media, a personal digital assistant (PDA), or a compact disc (CD). In many embodiments, export module 404 is part of an application management API installed in the original environment.

Policies module 406 allows the user an opportunity to modify the configuration data currently maintained in the EAR file and/or append additional configuration data. In particular, policies module 406 determines which attribute values of the environment configuration data are static and which are variable. Also, the policies module 406 saves input from the user concerning variable configuration data. In further embodiments, policies module 406 may automatically adapt the configuration data based upon default data and/or calculated data associated with the target environment.

Repackage module 408 may recombines the static and variable configuration data into a new archive file such as an extended EAR file. In replacing variable configuration data with, e.g., user selections and recombining that data with the static configuration data, the repackage module 408 reduces errors typically involved with manually modifying the configuration data in the target environment.

Configuration module 410 may configure the server, and environment based on the static and variable configuration data. In many embodiments, configuration module 410 interacts with an application management API in the target environment to implement the changes. In another embodiment, configuration module 410 may configure the environment based on default values stored on a file server, removable media, hard disk, or the like.

Import module 412 imports the bundle to a directory in the target environment once the environment is sufficiently configured. Alternatively, import module 412 may import the bundle to the target environment before configuration module 410 prepares the target environment for installation of the application. In several embodiments, import module 412 is part of the application management API installed in the target environment.

Install module 414 installs the application in the target environment, locating components of the application in directories described by descriptor files and linking components of the application to various resources available in the target environment. After install module 414 installs the application, the user is able to run the application in the target environment for testing, production, or the like.

FIG. 5 depicts an embodiment of an automated Application Deployment System that is a simplified example of a computer system 500 capable of deploying a J2EE application between environments. In one embodiment, computer system 500 includes an original host system 501 and a target system 502 as nodes in a cluster. Original host system 501 and target system 502 may be implemented as a group of servers, which when grouped with shared storage 503, offer availability to reduce computer system 500 downtime.

Shared storage 503 may include a Direct Attached Storage (DAS); Storage Area Network (SAN); Network Attached Store (NAS); or other storage devices. Direct attached storage directly attaches to one of the nodes (original system 501 or target system 502) as a host system. An example of DAS is an internal or external hard drive of a server computer. A SAN, such as an IBM TotalStorage SAN Director M14, is a high-speed special-purpose network that interconnects data storage devices with data servers on behalf of a larger network. Additionally, shared storage 503 may be a server dedicated to file sharing or other NAS, such as IBM TotalStorage Network Attached Storage 300G. A NAS includes hard disk storage, multi-disk RAID systems, and software for configuring and mapping file locations to the nodes (original system 501 or target system 502). A NAS device may also exist internal or external to a server, attach to a local area network, be assigned an internet protocol (IP) address, and further include multiple networked NAS devices.

Networks, sometimes referred to as interconnects, may also be physically independent and provide communication to the nodes in the cluster. Network adapters, also known as network interfaces, attach nodes to the networks. One particular network adapter is also known as a private network adapter or heartbeat 504. To aid reliable communication, heartbeat 504 transmits messages to monitor for malfunctioning nodes or links.

Shared storage buses (504, 505) couple one or more disks to the cluster; the disks, such as, shared storage 503, store computer system 500 configuration and resource data. In one embodiment, automated Application Deployment system 595 resides in shared storage 503. Administrators may manage cluster objects by manipulating the properties with a cluster management application or command line. Properties or data values are associated with server cluster objects and describe a server cluster object's identity and behavior in the cluster. A server cluster object may generally refer to original host system 501, target system 502, resources, resource types, networks, network interfaces, and the like. In particular, an administrator may use an application bundle as described in FIG. 1, automated Application Deployment system 595 to manipulate the bundle and cluster object properties to configure and deploy an application from the original system to the target system. Further, developers may use server cluster APIs to modify applications to be cluster-aware and to create cluster management applications and custom resource types to provide performance-enhancing cluster interaction to the application.

In one embodiment, cluster software monitors server hardware and the application. As well, the cluster software detects faults and errors. Through cluster software the nodes are aware of resources that are running locally as well as resources running on other cluster nodes. Both of the shown nodes (original system 501 and target system 502) have access to cluster configuration data and automated Application Deployment system 595 on shared storage 503. In one embodiment, shared storage 503 and other devices common to the cluster are physically available to all nodes in the cluster, however, only owned by one node at a time. A change in resource ownership involves a reservation and contention protocol in this shared-nothing programming approach. Other programming approaches to resource management include shared-disk and Single System Image (SSI). An embodiment that includes shared-disk resource management includes a distributed lock manager to detect and resolve conflicts in accessing data and to track and provide access to cluster resources for all applications. Alternately, the SSI resource management collects physically separate servers into what users, applications, and middleware processes see as a single operating system and server. A single set of file systems, and all nodes in the cluster use the same root file system; and devices, log files, and network interfaces are named uniquely throughout the cluster.

While the computer system described in FIG. 5 is capable of executing the invention described herein, this computer system is simply one example. Those skilled in the art will appreciate that many other computer system designs as well as networks of multiple computer systems are capable of performing the invention described herein. In other embodiments, Application Deployment system 595 may operate on an individual computer that is logically partitioned, one machine with multiple processors, or on multiple machines sharing a hard disk.

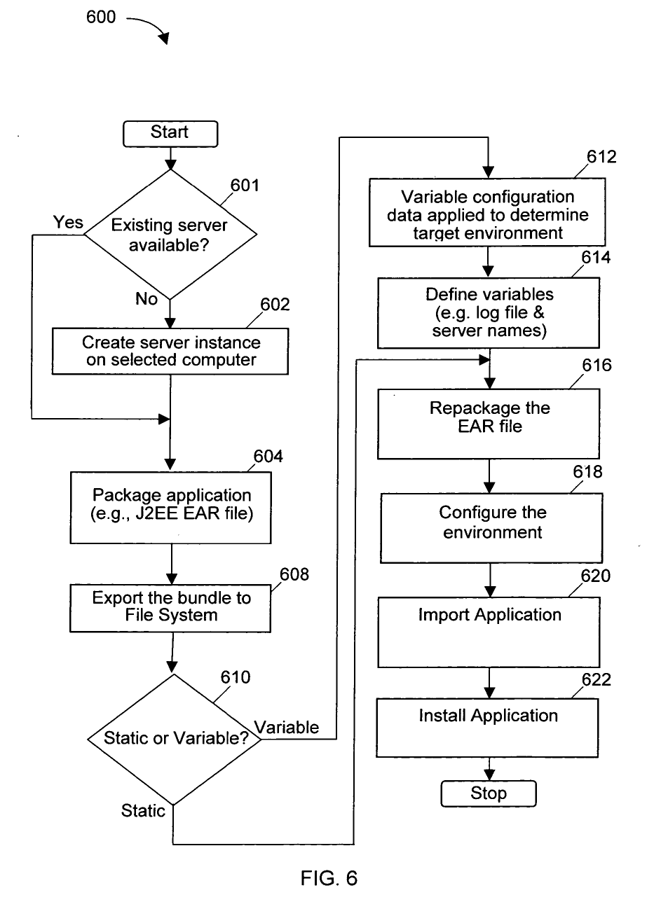

Turning to FIG. 6, depicts an example of a flowchart 600 to deploy an application between an original environment and a target environment. Flowchart 600 begins in response to an instruction to deploy an application in a target environment. The instruction may be, e.g., an instruction from a user or an instruction initiated as an automatic response to an event such as completion of testing in the original environment. For example, deployment may initiate in response to expiration of a timer set by a user to deploy the application from one test station to another test station. Further, another computer system or server instance may instruct the deployment.

In some embodiments, the application deployment system determines whether or not a server instance necessary for execution of the application already exists in the selected target environment (element 601). The application deployment system creates the server instance if the selected target environment does not include an existing computer (element 602). Thus, the user can advantageously feature deploy the application to the target environment missing the server, without necessarily having the requisite technical knowledge to install and configure a server instance in the target environment manually.

Next the application deployment system may compress information about the application into, e.g., a J2EE EAR file (element 604). In one embodiment, the application deployment system packages and compresses the application into an EAR file including application data, configuration data, and possibly deployment descriptors. Compressing provides a smaller size file that is more easily transmitted from original environment to target environment.

In some embodiments, the Application deployment system may export the bundled information to a file system (element 608). While on the file system, variable configuration data is also bundled in the J2EE EAR file to adapt the configuration data for the target environment. In some embodiments, the bundled information may be physically transferred by floppy disks or other external storage devices.

Configuration data is hen parsed to determine whether the data is static or variable. In some embodiment, pre-selected portions or all of the configuration data is available for modification by the user. For instance, some configuration data may remain static in more than one of the environments so the user may not be offered the opportunity to identify that configuration data as variable for one or more of the environments.

After identifying variable configuration data, the user may input or select the adapted configuration data for the target environment (element 610). For the variable configuration data, policies are applied to determine the configuration data based upon the target environment (element 612). For example, a user may prefer an alternate log file or server name depending upon the, e.g., design or configuration of the target environment.

The configuration data that is determined based upon the target environment is then associated with the J2EE EAR file to define, e.g., log file and server names (element 614). Advantageously, identifying portions of the configuration data as static, in many embodiments, relieves the user of any further configuration determinations associated with the static configuration data for the target environment. Configuration of the target environment based upon the static configuration data is automatically handled. In another embodiment, the default files with reoccurring values for portions of the configuration data may be stored to a file so the user can simply select the adapted configuration data. For example, a user may establish a file of recurring values that the user frequently implements for multiple deployments of an application.

The application deployment system next recombines the static and variable configuration data into a new, extended EAR file (element 616). Subsequently, the application deployment system may configure the target environment based on the static and variable values (element 618). The Application deployment system automates this configuration of the environment; thus, configuring the matching values to the bundled information is a less error-prone manner than manual configuration of the target environment. Alternatively, the application deployment system may deploy the application based on substitute configuration data from another source. For example, the user may opt to deploy an application to a target environment according to the configuration of another installation of the application in another environment. More particularly, during the deployment of the application to the target environment, the extended EAR file may be copied from another environment into the target environment to deploy the application.

After the application deployment system configures the target environment, the application deployment system may import the extended EAR file to a directory in the target environment (element 620). In one embodiment, the application deployment system may publish the extended EAR file to a directory in the target environment, unpack the extended EAR file, and write subdirectories of the source objects into the target environment. Also, if present, the system may encounter and unpack a WAR file and write subdirectories of those source objects into the target environment. Thus, subdirectories and the application may be set up in the target environment and the application is ready for the computer to install.

With the target environment configured for installation of the application, the application deployment system installs the application in the target environment (element 622). As part of installation in one embodiment, the Application deployment system may link the application to components of the target environment, such as the server. For example, a Java virtual machine runtime process (JVM), which interprets compiled Java code for a computer's processor, may execute the application in the target environment.

Embodiments of the invention such as system 100 of FIG. 1 and extended EAR file of FIG. 3 may be implemented as program products. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); (iii) CD-ROM disks read/write-able by a CD-ROM drive; and (iv) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, indicate embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, any particular program nomenclature that follows is used merely for convenience, and thus the invention should not be limited to use solely in any specific application identified and/or implied by such nomenclature.

Those skilled in the art having the benefit of this disclosure will be aware that the present invention contemplates methods and arrangements for automated deployment of an application into a target environment. Understanding that the form of the invention shown and described in the detailed description and the drawings are to be taken merely as examples. The following claims are to be interpreted broadly to embrace all the variations of the example embodiments disclosed.

1. A method to deploy an application on a target environment, comprising:
gathering static configuration data related to deployment of the application, the static configuration data describing a relationship between the application and another environment, wherein the relationship is applicable to deployment of the application onto the target environment;
determining variable configuration data for the application based upon the target environment;
configuring the target environment for deployment of the application based upon the static configuration data and the variable configuration data; and
installing the application in the target environment.

2. The method of claim 1, further comprising checking the target environment for a server instance based upon the static configuration data and the variable configuration data.

3. The method of claim 1, wherein gathering comprises gathering an application archive file from an original environment, the application archive having the application and configuration data, wherein the configuration data comprises the static configuration data.

4. The method of claim 3, wherein configuring the target environment comprises defining the server instance in the target environment in response to an absence of the server instance in the target environment.

5. The method of claim 3, wherein gathering the application archive file comprises creating the application archive file in the original environment and exporting the application archive file from the original environment.

6. The method of claim 3, wherein determining the variable configuration data comprises determining that a portion of the configuration data in the archive file is variable with respect to the target environment.

7. The method of claim 5, wherein determining the variable configuration data comprises interacting with a user to determine the variable configuration data.

8. The method of claim 1, wherein configuring the target environment comprises configuring the target environment based upon default configuration data.

9. The method of claim 1, wherein installing the application comprises importing an extended enterprise archive (EAR) file into the target environment and installing the application from the extended EAR file.

10. The method of claim 1, wherein installing the application comprises linking the application to a server instance, a database, and a virtual host in accordance with the static configuration data and the variable configuration data.

11. An apparatus to deploy an application on a target environment, comprising:
a package module to gather static configuration data related to deployment of the application, the static configuration data describing a relationship between the application and another environment, wherein the relationship is applicable to deployment of the application onto the target environment
a policies module to determine variable configuration data for the application based upon the target environment;
a configuration module to configure the target environment for deployment of the application based upon the static configuration data and the variable configuration data; and
an install module to install the application in the target environment.

12. The apparatus of claim 11, further comprising an export module to export the application from an original environment in an archive file, the archive file having configuration data associated with the original environment, wherein the configuration data comprises the static configuration data.

13. The apparatus of claim 12, wherein the policies module is designed to determine that a portion of the configuration data in the archive file is variable with respect to the target environment.

14. The apparatus of claim 11, further comprising a repackaging module to respond to input from the user to change the variable attribute within the system configuration data.

15. The apparatus of claim 11, wherein the package module is adapted to create an extended archive file having the application, the static configuration data and the variable configuration data to transmit to the target environment.

16. The apparatus of claim 15, further comprising an import module to import the extended archive file to the target environment.

17. The apparatus of claim 11, wherein the policies module is designed to interact with a user to determine the variable configuration data.

18. The apparatus of claim 11, wherein the configuration module is able to configure the target environment based upon default configuration data.

19. The apparatus of claim 11, wherein the configuration module is adapted to check the target environment for a server instance based upon the static configuration data and the variable configuration data, and create the server instance in the absence of the server instance in the target environment.

20. An application archive file for deploying an application on a target environment, comprising:
an application selected for deployment on the target environment; and
configuration data for adapting the target environment for deployment of the application comprising static configuration data related to deployment of an application, the static configuration data describing a relationship between the application and another environment, wherein the relationship is applicable to deployment of the application onto the target environment; and variable configuration data for the application based upon the target environment.

21. The application archive file of claim 20, wherein the configuration data comprises a definition for a server instance to create the server instance in the target environment.

22. The application archive file of claim 20, wherein the configuration data comprises a definition for a virtual host to create the virtual host in the target environment.

23. The application archive file of claim 20, wherein the configuration data describes a link between the application and a resource of the target environment.

24. The application archive file of claim 20, wherein the configuration data describes a link between the application and a server of the target environment.

25. The application archive file of claim 20, wherein the configuration data reflects a default configuration selected by a user.

26. A machine-accessible medium containing instructions, which when executed by a machine, cause said machine to perform operations, comprising:
gathering static configuration data related to deployment of an application, the static configuration data describing a relationship between the application and another environment, wherein the relationship is applicable to deployment of the application onto a target environment;
determining variable configuration data for the application based upon the target environment;
configuring the target environment for deployment of the application based upon the static configuration data and the variable configuration data; and
installing the application in the target environment.

27. The machine-accessible medium of claim 26, wherein the operations further comprise checking the target environment for a server instance based upon the static configuration data and the variable configuration data.

28. The machine-accessible medium of claim 26, wherein gathering comprises gathering an application archive file from an original environment, the application archive having the application and configuration data, wherein the configuration data comprises the static configuration data.

29. The machine-accessible medium of claim 26, wherein configuring the target environment comprises defining the server instance in the target environment in response to an absence of the server instance in the target environment.
